(19) United States
(12) Patent Application Publication
(10) Pub. No.: US 2005/0221840 A1
(43) Pub. Date: Oct. 6, 2005

(54) Mobile device and mobile device system therefor

(75) Inventors: Daisuke Yamamoto, Kyoto (JP); Hideki Ogawa, Kanagawa-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/087,692

(22) Filed: Mar. 24, 2005

(30) Foreign Application Priority Data
Mar. 24, 2004 (JP) P2004-87069

(51) Int. Cl. H04B 3/36; H04B 7/14; H04Q 7/20

(52) U.S. Cl. 455/456.3; 455/456.1

(57) ABSTRACT

A mobile device system including an autonomously-movable mobile device and a supply device for supplying power to the mobile device, and a related method and computer program product. The mobile device includes a driving unit, a position measuring unit for measuring the position of the mobile device, a route generating unit for generating a route from the mobile device to the supply device, a controller for controlling the driving unit according to the route, and a battery. The supply device includes a recognizing unit for recognizing an object located within some range around the supply device, a calculator for calculating the relative position of the mobile device to the supply device on the basis of a recognition result of the recognizing unit, and a communicating unit for transmitting the relative position to the mobile device, and on the basis of the relative position, the mobile device moves to a position at which the supply device can supply power to a rechargeable battery.

### CROSS REFERENCE TO RELATED APPLICATIONS

This application is based upon and claims the benefit of priority from the prior Japanese Patent Application No. 2004-87069, filed on Mar. 24, 2004, the entire contents of which are incorporated herein by reference.

### FIELD OF THE INVENTION

The present invention relates to a mobile device and a system for assisting the mobile device.

### DESCRIPTION OF THE RELATED ART

Various conventional methods of guiding a self-propelled type mobile device (hereinafter referred to as “robot”) are available. According to one of these methods, a guide cable for emitting electromagnetic waves or a guide tape or the like is laid along a route on which the robot will move. The robot may move back and forth along the guide cable or guide tape etc as required by the robot's duties. However, this method requires extensive labor to install the guide cable or guide tape. In addition, in order to change the route, it is necessary to lay a new guide cable along the new route.

Conventional robots may also use a method of enabling a robot to know its position based on information provided by a gyro or based on the number of rotations of one or more wheels on the robot. For example, if a monitored wheel of 0.5 meters circumference turns through 20 complete revolutions and the robot has not changed direction, the robot has traveled 10 meters. However, these methods produce inaccurate robot location information due to variations in the size and shape of the measurement wheel or drift of the gyro. When this these inaccuracies accumulate, the robot cannot reliably find its way to any instructed location.

In order to overcome the above disadvantages, a monitoring unit for monitoring the movement of the robot from the outside may be set up at a position where the area accessible to the robot can be viewed. Conventional robot systems use a method of guiding a robot while a monitoring unit communicates with the robot (JP-A-2001-325023; Patent Document 1).

Conventional robot systems also use a method of equipping a charging device with a recognizing unit for recognizing a robot and then guiding the robot to a chargeable position by the charging device (JP-A-2003-1577; Patent Document 2). The charging device is a kind of home base. The robot goes about its daily tasks and then returns to the charging unit as necessary to recharge. When the charging unit is equipped with a recognizing unit capable of detecting the robot, the charging unit can assist the robot in finding its way back to the charging unit.

With respect to the method disclosed in the Patent Document 1, in order to monitor the area accessible to the robot and specify the position of the robot, it is necessary to set up the monitoring unit at a position from which the robot can be viewed (for example, a high position such as a ceiling or the like). Furthermore, when the area accessible to the robot is large, it is necessary to set up plural monitoring units. Accordingly, one disadvantage of this method is that it is difficult to set up the monitoring units in multiple locations, especially if those locations are inconvenient to reach.

When the monitoring unit comprises an image pickup device such as CCD or CMOS sensor or the like, the monitoring unit receives an image of the area accessible to the robot at all times. Therefore, this method is not favorable when human occupants of an area patrolled by the robot desire privacy, for example, in a personal home. Furthermore, because the image is electronically transmitted, it may be possible for hackers to intercept the image received by the robot.

With respect to the method disclosed in the Patent Document 2, when the recognizing unit does not recognize the robot at first, the robot must move to a position where the recognizing unit of the charging device can recognize the robot. While moving around and waiting to be recognized, the robot may run out of power. Thus, the robot stops moving before the arriving at the charging device. Furthermore, in order to enable the robot to be recognizable at all times, it is often necessary to provide many charging devices or recognizing units. Providing more than one recognizing device increases the cost of the overall system.

### SUMMARY OF THE INVENTION

According to one aspect of the present invention, there is provided a system having an autonomously-movable mobile device and a supply device configured to supply power or fuel to the mobile device. The system may include a mobile device configured to move to a position at which a supply device can supply power or fuel to the mobile device including, a driving unit configured to move the mobile device, a position measuring unit configured to measure a position of the mobile device, a route generating unit configured to generate a route from the position of the mobile device to a position of the supply device, a controller configured to control the driving unit based on the route generated by the route generating unit, a communicating unit configured to communicate with the supply device, and a mobile device battery disposed in the mobile device and configured to supply power to the mobile device. Additionally, the supply device configured to supply power or fuel to the mobile device includes a recognizing unit configured to recognize an object located within a range around the supply device, a calculator configured to calculate a position of the mobile device relative to the supply device based on a recognition result of the recognizing unit, a communicating unit configured to transmit to the mobile device a position of the mobile device relative the supply device, a supply device battery or supply unit configured to supply power to the mobile device battery, and a charger configured to charge the supply device battery or supply unit.

According to another aspect of the present invention, there is provided a system having an autonomously-movable mobile device and a supply device configured to supply power or fuel to the mobile device, including, a mobile device configured to move to a position at which a supply device can supply power or fuel to the mobile device based on a position of the mobile device relative to the supply device including, a driving unit configured to move the mobile device, a position measuring unit configured to measure the position of the mobile device, a route generating unit configured to generate a route from the position of the mobile device to the position of the supply device, a controller configured to control the driving unit based on the route generated by the route generating unit, a communicating unit configured to communicate with the supply device, and a mobile device battery device configured to supply power to the mobile device. Additionally, the supply device configured to supply power or fuel to the mobile device includes a recognizing unit configured to recognize an object located within a range around the supply device, a communicating unit configured to transmit a recognition result of the recognizing unit to the mobile device, a charging unit configured to supply power to the mobile device battery, and a calculator disposed in the supply device and configured to calculate a position of the mobile device relative to the supply device based on the recognition result of the recognizing unit.

According to a further aspect of the present invention, there is provided a mobile device system, including an image pickup unit and an autonomously-movable mobile device, a driving unit configured to move the mobile device, a position measuring unit configured to measure a position of the mobile device, a route generating unit configured to generate a route from the position of the mobile device to a supply device configured to supply power or fuel, a controller configured to control the driving unit based on the route generated by the route generating unit, a calculator configured to calculate a position of the mobile device relative to the supply device and a direction of movement of the mobile device based on images of the mobile device or images of the supply device, and a mobile device battery disposed in the mobile device and configured to supply power to the mobile device.

According to still a further aspect of the present invention, there is provided an autonomously-movable mobile device, including a driving unit configured to move the mobile device, a position measuring unit configured to measure a position of the mobile device, a route generating unit configured to generate a route between the mobile device and a supply device, a controller controls the driving unit based on the route generated by the route generating unit, a communicating unit configured to communicate with the supply device, and a battery disposed in the mobile device configured to supply power to the mobile device, and the mobile device is able to move to a position at which the supply device can supply power to the battery based on a position of the mobile device relative to the supply device calculated by the supply device.

According to yet another aspect of the present invention, there is provided a method of guiding a mobile device to a supply device to recharge the mobile device, including collecting first information regarding a location of the mobile device via measurement equipment disposed in the mobile device, storing the location of a supply device in memory, generating a first route from the mobile device to a supply station based on the location of the mobile device and the location of the supply device, moving the mobile device along the first route, sensing second information regarding the location and direction of movement of the mobile device via at least one sensor located on the supply device, processing the second information to determine the location and direction of movement of the mobile device, generating a second route from the mobile device to the supply device based on the information transmitted to the mobile device, moving the mobile device along the second route, joining the mobile device with the supply device, and supplying power to the mobile device from the supply device.

According to a further aspect of the present invention, there is provided a computer program product which stores computer program instructions which, when executed by a computer system programmed with the computer program instructions, results in performing the steps including receiving first information regarding a location of a mobile device, storing second information regarding the location of a supply device, calculating a first route between the mobile device and the supply device based on the received first information and stored second information, generating drive signals to a drive unit of the mobile device to move the mobile device along the calculated first route, receiving third information from at least one sensor located on the supply device, processing the third information to determine the location and direction of movement of the mobile device, calculating a second route from the mobile device to the supply device, and generating drive signals to a drive unit of the mobile device to move the mobile device along the calculated second route.

According to another aspect of the present invention, there is provided a system having an autonomously-movable mobile device and a supply device configured to supply power or fuel to the mobile device, including a mobile device configured to move to a position at which a supply device can supply power or fuel to the mobile device. The mobile includes a driving unit configured to move the mobile device, a mobile device battery disposed in the mobile device and configured to supply power to the mobile device, and a means for guiding the mobile device into an area where a supply device can sense the mobile device. The supply device configured to supply power or fuel to the mobile device includes a supply device battery or supply unit configured to supply power to the mobile device battery, a charger configured to charge the supply device battery or supply unit, and a means for guiding the mobile device into a position where the supply device supply power to the mobile device.

According to one aspect of the mobile device system and the mobile device of the present invention, the system can reliably guide the mobile device to the charging device while reducing the need to dispose multiple monitoring units for the mobile device in inconvenient locations.

### BRIEF DESCRIPTION OF THE DRAWINGS

A more complete appreciation of the invention and many of the attendant advantages thereof will be readily obtained as the same become better understood by reference to the following detailed description when considered in connection with the accompanying drawings.

FIG. 1 is a block diagram showing a robot system 100 according to a first embodiment of the present invention;

FIG. 2 is a flow chart showing processing performed by the robot system 100;

FIG. 3 is an overhead view of the approach of the robot 101 to the charging station 102;

FIG. 4 is another overhead view of the approach of the robot 101 to the charging station 102;

FIG. 5 is another overhead view of the approach of the robot 101 to the charging station 102;

FIG. 6 is an overhead view showing a method of calculating the relative position of the robot 101 to the charging station 102;

FIG. 7 is a side view illustrative of the method of calculating the relative position of the robot 101 to the charging station 102;

FIG. 8 is a block diagram showing a robot system 200 according to a second embodiment of the present invention;

FIG. 9 is a block diagram showing a robot system 300 according to a third embodiment of the present invention; and

FIG. 10 is an overhead view showing a method of detecting a moving object in the third embodiment.

### DETAILED DESCRIPTION

Referring now to the drawings, wherein like reference numerals designate identical or corresponding parts throughout the several views, other features of the invention will become apparent in the course of the following descriptions of exemplary embodiments which are given for illustration of the invention and are not intended to be limiting thereof.

Numerous modifications and variations of the present invention are possible in light of the above teachings. It is therefore to be understood that within the scope of the appended claims, the invention may be practiced otherwise than as specifically described herein.

### First Embodiment

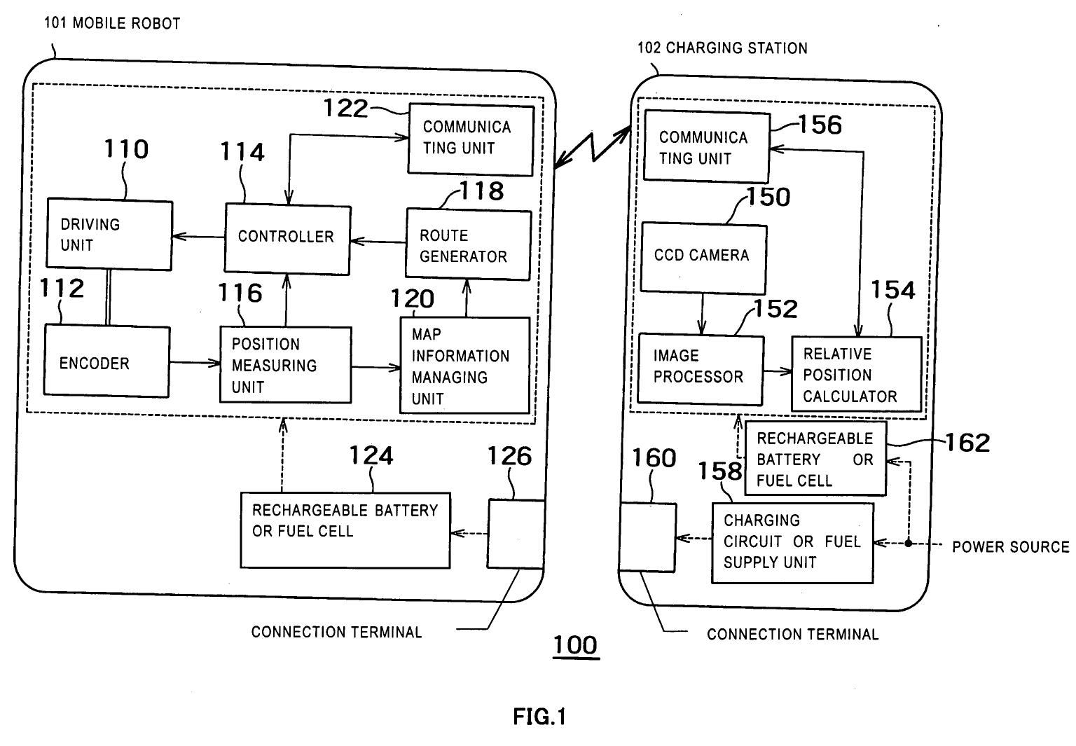

FIG. 1 is a block diagram showing a robot system 100 according to a first embodiment of the present invention. A robot system 100 has a robot 101 and a charging station 102.

The robot 101 is equipped with a driving unit 110, an encoder 112, a controller 114, a position measuring unit 116, a route generating unit 118, a map information managing unit 120, a communicating unit 122, a rechargeable battery or fuel cell (hereinafter referred to as “rechargeable battery”) 124 and a connection terminal 126. The robot 101 is a self-propelled type robot which autonomously moves in a factory, an office, a private home or the like. The robot may perform a variety of tasks related to the specific area of deployment.

In one non-limiting embodiment, the driving unit 110 is a motor for driving two right and left wheels (not shown) of the robot 101. For measuring the position of the robot 101, the encoders 112 are secured to each of the right and left wheels to measure the number of rotations or partial rotations of these wheels. The position measuring unit 116 measures the position of the robot 101 on the basis of the number of rotations or partial rotations of the right and left wheels measured by the encoders 112. As the position measuring unit 116 monitors both wheels, the position measuring unit 116 can determine changes of direction of the robot.

The map information managing unit 120 stores map information relating to the area accessible to the robot 101. This map information contains various data on the positions of obstacles to the movement of the robot 101, the position of the robot 101 measured by the position measuring unit 116, the location of the charging station 102, the working position (orientation) of the robot 101, etc. The position of the charging station 102 is normally fixed, i.e., the charging station 102 does not move.

The route generating unit 118 generates a moving route for the robot 101 by referring to the map information stored in the map information managing unit 120. For example, the route generating unit 118 creates a moving route from the present position of the robot 101 to a position at which a task will carried out by the robot 101. The route generating unit 118 also creates a moving route from the position of the robot 101 to the position of the charging station 102. The controller 114 controls the driving unit 110 along the route generated by the route generating unit 118. More specifically, the controller 114 calculates the number of rotations or partial rotations of both the wheels of the robot 101 necessary to move the robot 101 to a destination along the moving route. The controller 114 controls the driving unit 110 on the basis of the rotational number thus calculated. The communicating unit 122 can receive information on the position of the robot 101 relative to the charging station 102 from the charging station 102. The communicating unit 122 can also receive information on the direction of movement of the robot 101 from the charging station 102.

Each of the controller 114, the position measuring unit 116 and the route generating unit 118 may be implemented as discrete CPUs or all of them may be implemented collectively as a single CPU. A conventional memory device available on the open market may be used as the map information managing unit 120. The controller 114, the position measuring unit 116, the route generating unit 118 and the map information managing unit 120 maybe implemented as a single LSI. The communicating unit 122 may be implemented by wireless LAN (Local Area Network).

The rechargeable battery 124 supplies power to each of the elements of the robot 101 described above. The connection terminal 126 is designed to be connectable to the connection terminal 160 of the charging station 102. The connection terminal 126 and the connection terminal 160 may connect to each other so that a charging circuit 158 of the charging station charges the rechargeable battery 124. When a fuel cell is used in place of the rechargeable battery 124, a fuel supply unit supplies fuel to the fuel cell 124 through the connection terminals 126 and 160 in place of the charging station 102.

In one non-limiting embodiment, the charging station 102 is equipped with a CCD camera 150, an image processor 152, a relative position calculator 154, a communicating unit 156, a charging circuit 158, a connection terminal 160 and a rechargeable battery 162. The CCD camera 150 is disposed so that it can receive images within an area around the charging station 102. This predetermined image pickup range is not necessarily equal to the entire area accessible to the robot 101. As a non-limiting example, the image pickup range could be an area near the floor around the charging station 102. Such a pickup range enhances the privacy of any human occupants in the range. The image pickup range would only include the feet of the occupants. For example, this predetermined range is set to be located within several tens degrees around the charging station 102. Furthermore, the CCD camera 150 is preferably oriented in a direction along which the robot 101 makes its way to connect to the connection terminal 160 of the charging station 102.

As shown in FIG. 1, the image processor 152 processes the image picked up by the CCD camera 150. For example, the image processor 152 detects a moving object in the image and recognizes the robot 101 on the basis of action taken by the detected object or the like. The relative position calculator 154 calculates the position of the robot 101 relative to the charging station 102 and the direction of movement of the robot 101. The communicating unit 156 transmits to the robot 101 the information describing the relative position of the robot 101 and the direction of movement of the robot 101.

The image processor 152 and the relative position calculator 154 may each be implemented by individual CPU or they may be collectively implemented by one CPU. The communicating unit 156 may be implemented as a wireless LAN.

As shown in FIG. 1, the charging circuit 158 is connected to the connection terminal 160 and a commercial external power source, and charges the rechargeable battery 124 by connecting the connection terminals 126 and 160 to each other. Furthermore, the rechargeable battery 162 is supplied with power from the external power source, and supplies power to the respective constituent elements of the charging station 102.

The rechargeable battery 162 may be a fuel cell rather than a conventional rechargeable battery. When the fuel cells 124 and 162 are used in place of the rechargeable battery, the charging circuit 158 is implemented as the fuel supply unit, and it supplies fuel to the fuel cells 124 and 162. In this case, the external power source is not necessary in the robot system 100.

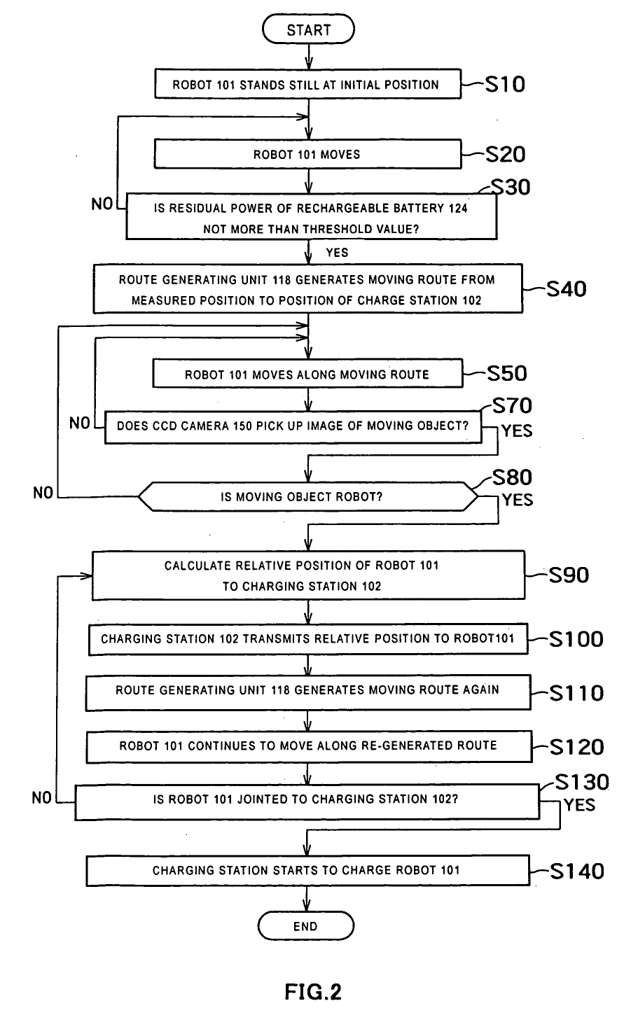

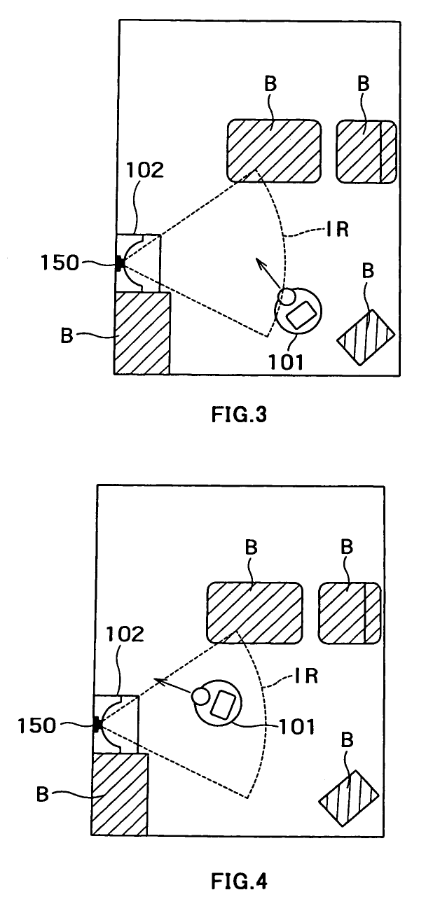

FIG. 2 is a flow chart showing the flow of the operation of the robot system 100. FIGS. 3 to 5 are overhead views of the robot 101 approaching the charging station 102. The operation of the robot system 100 will be described with reference to FIGS. 2 to 5. First, the robot 101 stands still at an initial position (S10). For example, the robot 101 is next to the charging station 102 as an initial position. The position measuring unit 116 measures the direction of movement and distance of the robot 101 with the initial position as an original point, and specifies the position of the robot 101 by using the map information in the map information managing unit 120.

Subsequently, the robot 101 starts to move from the initial position (S20). At this time, the position measuring unit 116 starts to measure the position of the robot 101. The robot 101 continues to move or work until the residual amount of power of the rechargeable battery 124 is reduced to a threshold value or less (S30). The threshold value of power is set to at least the amount of power needed for the robot 101 to move to the charging station 102.

When the residual amount of power of the rechargeable battery 124 is equal to the threshold value or less, the robot 101 is required to move to the charging station 102. In order for this to happen, the route generating unit 118 generates a moving route from the position of the robot 101 measured by the position measuring unit 116 to the position of the charging station 102 based on the map information (S40). At this time, the route generating unit 118 generates the route so that the route avoids obstacle areas B (see FIG. 3) registered in the map information in advance.

Subsequently, the robot 101 moves along the moving route thus generated, and approaches the neighborhood of the charging station 102 (S50). The position (measured position) of the robot 101 measured by the position measuring unit 116 is displaced to some degree from the position (actual position) at which the robot 101 actually exists. This error exists because the position measuring unit 116 measures the position of the robot 101 on the basis of the gyro or the number of rotations or partial rotations of a wheel. As discussed above, these methods are not completely accurate. However, in this embodiment, perfect accuracy is not necessary; it is sufficient for the robot 101 to enter an image pickup area IR of the CCD camera 150 shown in FIG. 3. Accordingly, the measured position of the robot 101 may be displaced from the actual position without a problem as long as the robot 101 is able to enter the image pickup area IR of the CCD camera 150.

As shown in FIG. 3, the robot 101 moves based on the position measured by the position measuring unit 116 until the CCD camera 150 of the charging station 102 picks up the image of the robot 101. As shown in FIG. 4, when the robot 101 enters the image pickup range IR, the CCD camera 150 picks up the image of the robot 101.

The image processor 152 first recognizes a moving object from the image of the CCD camera 150 (S70). At this time, the image processor 152 detects the moving object based on any difference between two sequential images. Subsequently, the image processor 152 identifies whether this moving object is the robot 101 (S80). More specifically, the charging station 102 receives operation information from the robot 101 such as the location and speed of the robot 101. The image processor 152 identifies the moving object as the robot when the operation information and the action of the moving object are substantially coincident with each other. In order to ensure the recognition of the robot 101, the operation information may contain the direction of movement and the measured position of the robot. However, when it is impossible to recognize the moving object as the robot because the error in measurement of the moving direction or the measured position is large, the moving direction or the measured position may be excluded from the operation information.

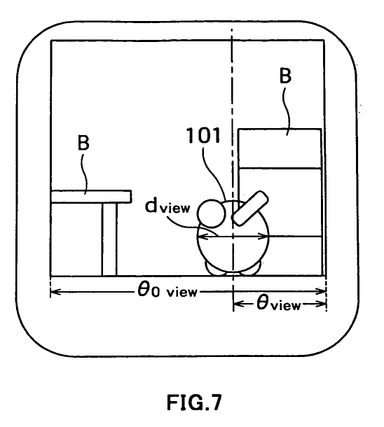

Subsequently, when the charging station 102 recognizes the robot 101, the charging station 102 calculates the position of the robot 101 relative to the charging station 102 (S90), and further transmits the information of the relative position to the robot 101 (S100). The moving speed, moving angle and relative position of the robot 101 will be described later with reference to FIGS. 6 and 7.

Subsequently, the robot 101 receives the information regarding its relative position from the charging station 102, and the route generating unit 118 in the robot generates a moving route again (S110). The map information managing unit 120 has information regarding the location of the charging station 102 in advance, and thus the route generating unit 118 calculates the actual position of the robot 101 on the basis of the position information regarding the charging station 102 and the relative position information of the robot 101. In step S110, the route generating unit 118 generates the route from the actual position of the robot 101 to the position of the charging station 102.

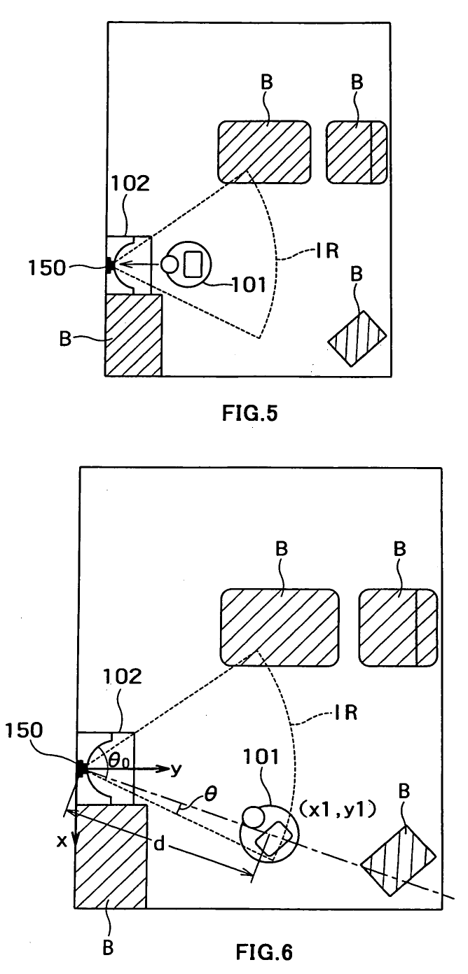

The robot 101 continues to move along the new route generated by the route generating unit 118 as shown in FIG. 5 (step S120). The steps S90 to S120 are repeated until the robot 101 joins with the charging station 102 (S130). When the robot 101 joins with the charging station 102 and the connection terminals 126 and 160 are connected to each other, the charging station 102 starts charging the robot 101 (S140) At the same time, the position measuring unit 116 of the robot 101 resets the measured position of the robot 101 and sets this position as a reference point.

FIG. 6 is an overhead view, and FIG. 7 is a side view showing a method of calculating the position of the robot 101 relative to the charging station 102 by the relative position calculator 154. FIG. 6 is a top view showing the charging station 102 and the robot 101. FIG. 7 shows an image picked up by the CCD camera 150.

First, as shown in FIG. 7, the relative position calculator 154 evaluates the image size (for example, diameter) d_{view} of the robot 101 viewed from the CCD camera 150 and the distance θ_{view} from one end of the visual field of the CCD camera 150 to the robot 101.

The overall distance θ_{0view} of the visual field of the CCD camera 150 and the angle θ₀ from one end to the other end of the image pickup area IR shown in FIG. 6 is known. Accordingly, the relative direction θ of the robot 101 to the CCD camera 150 is represented by θ₀*(θ_{view}/θ_{0view}).

Furthermore, the actual size (for example, diameter) d0 of the robot 101 is known. Accordingly, the relative distance d of the robot 101 to the CCD camera 150 is represented by d0/(tan(θ₀×d_{view})/(2×θ_{0view}) in the neighborhood of the center of the image, for example.

The relative position (x, y) of the robot 101 to the CCD camera 150 (charging station 102) is calculated from the relative direction θ and the relative distance d. In this embodiment, the position of the charging station 102 is set as the initial position, and thus the relative position (x, y) may be converted to the absolute position of the robot 101. Furthermore, the relative position (x, y) is renewed as needed, and feedback is applied until the position of the robot 101 is equal to (0, 0), and thus the precision of the location calculation of the robot in remote areas is need not be high.

In this embodiment, the charging station 102 is equipped with the CCD camera 150, and the charging station 102 recognizes the robot 101 through the CCD camera 150. Accordingly, it is unnecessary to have a monitoring unit or a recognizing unit in all the areas accessible to the robot 101. The CCD camera 150 may have some limited image pickup range IR, and may not pick up any image of objects out of this moving area. In addition, the moving robot moves on the floor surface, and thus the CCD camera 150 may be configured to pick up only images near to the floor surface. Accordingly, domestic privacy, etc. can be protected. Even when these images are hacked and intercepted, they are limited to the images within the image pickup range IR. In one non-limiting example, the image pickup range IR may be set so that the image pickup angle is set to 47 degrees in the right-and-left direction and 36 degrees in the vertical direction.

In this embodiment, since the robot 101 measures its own position, the robot 101 grasps its own location, albeit somewhat inaccurately. Accordingly, the robot 101 can easily enter the image pickup range IR according to the moving route without wandering around needlessly. Accordingly, it is necessary for the charging station 102 to pick up images of objects only in the image pickup range IR.

As described above, according to this embodiment, the robot 101 can be reliably guided to the charging station 102 without putting a monitoring unit in an inconvenient location. Additionally, fewer charging stations 102 may be necessary.

In one embodiment, the rechargeable battery 162 of the charging station 102 may be omitted. In this case, an external power source supplies power to each constituent element of the charging station 102.

### Second Embodiment

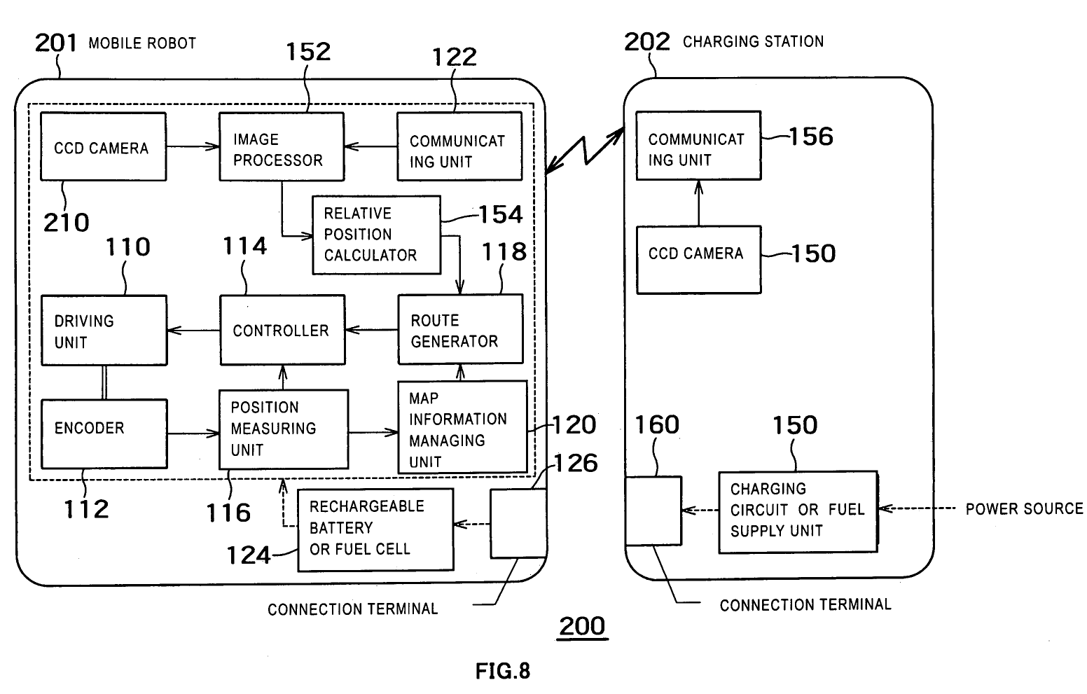

FIG. 8 is a block diagram showing a robot system 200 according to a second embodiment of the present invention. The second embodiment is different from the first embodiment in that the image processor 152 and the relative position calculator 154 are located in the robot 201.

The charging station 202 transmits an image picked up by the CCD camera 150 (located in the charging station 202) to the robot 201. The robot 201 processes this image to calculate its own position relative to the charging station. That is, the steps S70 to S90 of FIG. 2 carried out by the charging station 202 in the first embodiment are executed by the robot 201 in the second embodiment.

The second embodiment has the same ultimate effect as the first embodiment. The implementation of the charging station 202 is simpler in the second embodiment than in the first embodiment. Furthermore, the robot is normally provided with a CCD camera 210 for image pickup and identification of an object. The robot 201 normally also has an image processor needed to process the image thus picked up. In the second embodiment, the image sent from the charging station 202 can be processed by using the image processor 152 in the robot 201. Accordingly, it is unnecessary to put the image processor 152 in the charging station 202, and existing charging stations 202 can be effectively and practically used without adding an image processor 152.

### Third Embodiment

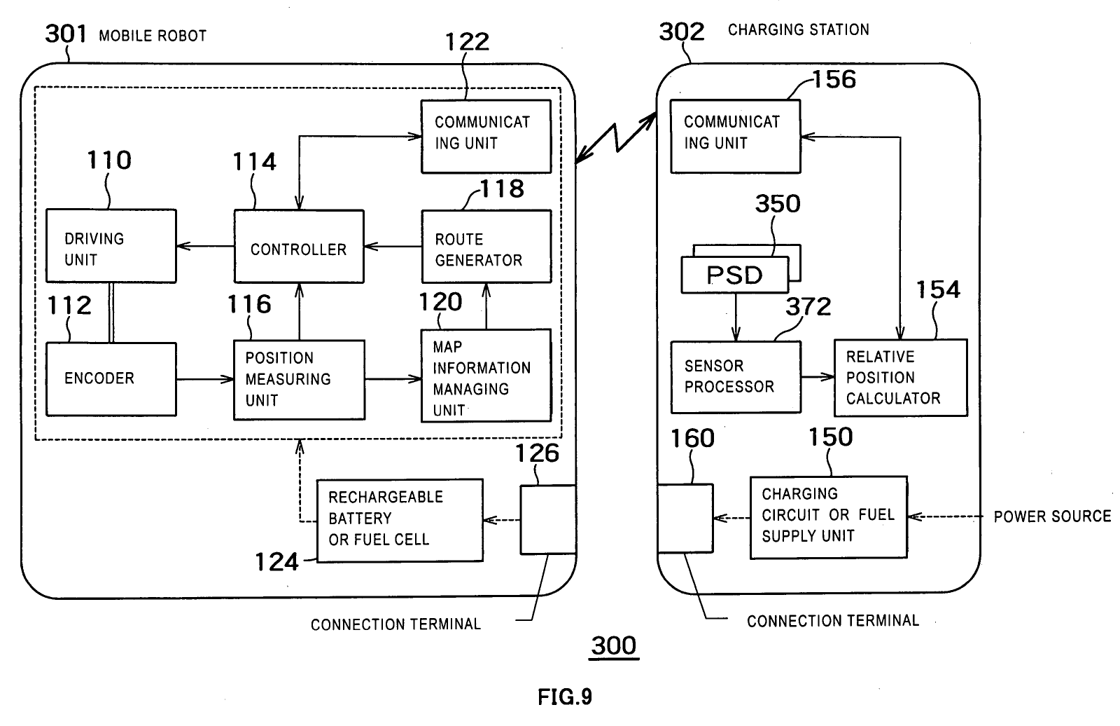

FIG. 9 is a block diagram showing a robot system 300 according to a third embodiment. The third embodiment is different from the first embodiment in that a PSD (Position Sensitive Detector) 350 is provided in place of the CCD camera 150. In connection with this difference, the third embodiment uses a sensor processor 372 in place of the image processor. PSD 350 can measure the distance to an object by using rays of emitted energy, for example, infrared rays.

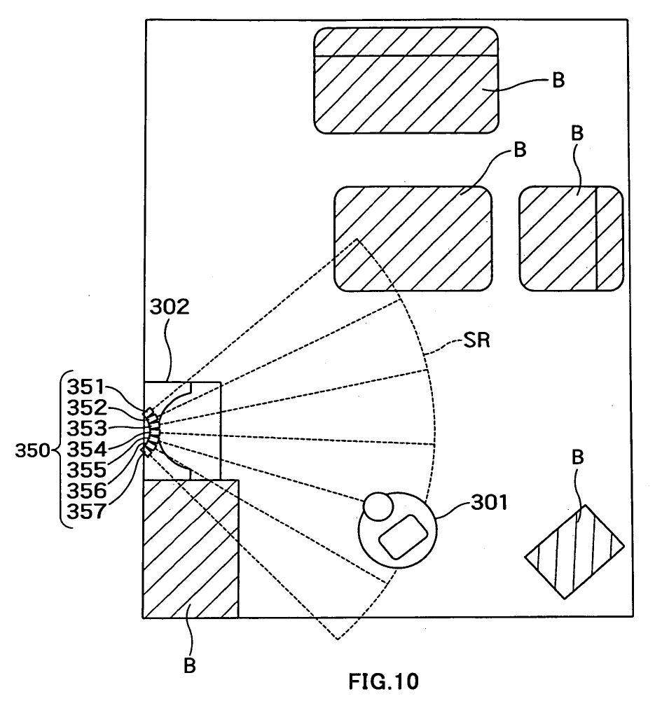

As shown in FIG. 10, a PSD unit 350 contains plural PSDs 351 to 357. PSDs 351 to 357 may be designed to emit rays at equal angular intervals in a hub and spoke pattern over a pie-shaped area. The range of the rays emitted from PSDs 351 to 357 is limited, and thus a detectable range SR of the rays is limited similar to the image pickup range IR of the CCD 150 used in the first and second embodiments.

The operation flow of the third embodiment is substantially identical to that of FIG. 2, and thus omitted. In this embodiment, the PSD unit 350 and the sensor processor 372 detects a moving object without being dependent on the image in step S70.

FIG. 10 is an overhead view showing a method of detecting an object in the third embodiment. First, the moving object is detected on the basis of continuous variation of the distance detected by PSDs 351 to 357. Furthermore, the sensor processor 372 can calculate the direction of movement and speed of the moving object by the variation of the distance to the objected detected by PSDs 351 to 357.

For example, when only the distance detected by the PSD 354 is shortened, the sensor processor 372 can determine that the moving object is moving directly along the ray emitted from PSD 354. The speed of the moving object can be calculated by periodically detecting the distance measured by PSD 354.

For example when the moving object moves at an angle to the charging station 302, the moving object traverses plural PSDs. In this case, the direction of movement and speed of the moving object can be calculated by measuring the variation of the distance based on the plural PSDs and the amount of time between measurements.

In order to identify whether the moving object is the robot 301 or not, the charging station 302 beforehand receives information from the robot 301 about its direction of movement and speed based on the measured position of the robot 301. The charging station 302 compares the information thus received with the direction of movement and speed of the moving object detected by the sensor processor 372. In this manner, the charging station 302 can identify the moving object as the robot 301.

Thereafter, in step S90 of FIG. 2, the relative position calculator 154 calculates the position of the robot 301 relative to the charging station 302. Each of PSDs 351 to 357 determines the distance to the robot 301 when the robot 301 traverses the ray emitted by that PSD. Furthermore, since PSDs 351 to 357 emit rays in predetermined directions, the direction of the location of the robot 301 from the charging station is automatically determined when the robot 301 traverses the rays. Accordingly, the relative position calculator 154 can calculate the position of the robot 301 relative to the charging station 302.

The third embodiment has the same ultimate function as the first embodiment. However, the third embodiment does not need any image processing, and thus the amount of data to be processed by the sensor processor 372 is relatively small. In other words, the calculation of the relative position of the robot 301 can be carried out in a relatively short time. Furthermore, the sensor processor 372 need not be as powerful a CPU as the image processor 152 of the first and second embodiments. Accordingly, a low-cost CPU can be used to implement the sensor processor 372.

In the third embodiment, the charging station 302 is provided with the sensor processor 372 and the relative position calculator 154. However, as in the case of the second embodiment of FIG. 8, the robot 301 may be provided with the sensor processor 372 and the relative position calculator 154. In this case, reference numerals 150 and 152 of FIG. 8 may be set as the PSD and the sensor processor. In this modification, the third embodiment is implemented similarly to the second embodiment.

The inventive system may also be conveniently implemented using a conventional general purpose computer or microprocessor programmed according to the teachings of the present invention, as will be apparent to those skilled in the computer art. Appropriate software can readily be prepared by programmers of ordinary skill based on the teachings of the present disclosure, as will be apparent to those skilled in the software art.

A general purpose computer may implement the method of the present invention, wherein the computer housing houses a motherboard which contains a CPU (central processing unit), memory such as DRAM (dynamic random access memory), ROM (read only memory), EPROM (erasable programmable read only memory), EEPROM (electrically erasable programmable read only memory), SRAM (static random access memory), SDRAM (synchronous dynamic random access memory), and Flash RAM (random access memory), and other optical special purpose logic devices such as ASICs (application specific integrated circuits) or configurable logic devices such GAL (generic array logic) and reprogrammable FPGAs (field programmable gate arrays).

The computer may also include plural input devices, (e.g., keyboard and mouse), and a display card for controlling a monitor. Additionally, the computer may include a floppy disk drive; other removable media devices (e.g. compact disc, tape, and removable magneto optical media); and a hard disk or other fixed high density media drives, connected using an appropriate device bus such as a SCSI (small computer system interface) bus, an Enhanced IDE (integrated drive electronics) bus, or an Ultra DMA (direct memory access) bus. The computer may also include a compact disc reader, a compact disc reader/writer unit, or a compact disc jukebox, which may be connected to the same device bus or to another device bus.

As stated above, the system includes at least one computer program product which stores computer program instructions which when executed by a computer causes performance of the method of the present invention. Examples of computer program products include compact discs, hard disks, floppy disks, tape, magneto optical disks, PROMs (e.g., EPROM, EEPROM, Flash EPROM), DRAM, SRAM, SDRAM, etc., which may store the instructions singularly or in combination. The software, in which the computer instructions are embedded, is for controlling both the hardware of the computer and for enabling the computer to interact with a human user. Such software may include, but is not limited to, device drivers, operating systems and user applications, such as development tools. Such software, can be any interpreted or executable code mechanism, including but not limited to, scripts, interpreters, dynamic link libraries, Java classes, and complete executable programs.

The computer program product may also be implemented by the preparation of application specific integrated circuits (ASICs) or by interconnecting an appropriate network of conventional component circuits, as will be readily apparent to those skilled in the art.

The present invention is not limited to the above embodiments, and constituent elements thereof may be modified without departing from the subject matter of the present invention. Furthermore, the present invention may be implemented by suitable combinations of the plural constituent elements disclosed in the above embodiments. For example, some constituent elements may be deleted from all the constituent elements disclosed in the above embodiments. Furthermore, the constituent elements of the different embodiments may be suitably combined.

1. A system having an autonomously-movable mobile device and a supply device configured to supply power or fuel to the mobile device, comprising:
a mobile device configured to move to a position at which a supply device can supply power or fuel to the mobile device including,
a driving unit configured to move the mobile device,
a position measuring unit configured to measure a position of the mobile device,
a route generating unit configured to generate a route from the position of the mobile device to a position of the supply device,
a controller configured to control the driving unit based on the route generated by the route generating unit,
a communicating unit configured to communicate with the supply device; and
a mobile device rechargeable power source disposed in the mobile device and configured to supply power to the mobile device; and
the supply device configured to supply power or fuel to the mobile device, the supply device including,
a recognizing unit configured to recognize an object located within a range around the supply device,
a calculator configured to calculate a position of the mobile device relative to the supply device based on a recognition result of the recognizing unit,
a communicating unit configured to transmit to the mobile device a position of the mobile device relative the supply device,
a supply device rechargeable power source configured to supply power to the mobile device battery; and
a charger configured to charge the supply device rechargeable power source.

2. The system according to claim 1, wherein the recognizing unit contains an image pickup unit configured to receive images of the range around the supply device, and the calculator is configured to calculate the position of the mobile device relative to the supply device and a direction of movement of the mobile device based on images received by the image pickup unit.

3. The system according to claim 1, wherein the calculator is configured to calculate a position of the mobile device relative to the supply device and a direction of movement of the mobile device based on a difference between plural images received by the recognizing unit.

4. The system according to claim 1, wherein the recognizing unit comprises plural ranging units configured to detect a distance between the supply device and an object separate from the supply device, and the calculator is configured to calculate a position of the mobile device relative to the supply device and a direction of movement of the mobile device based on a variation of distance measured by each of the ranging units.

5. The system according to claim 1, wherein the position measuring unit is configured to set the position of the supply device as a reference position or initial position in relation to position measurement of the mobile device.

6. A system having an autonomously-movable mobile device and a supply device configured to supply power or fuel to the mobile device, comprising:
a mobile device configured to move to a position at which a supply device can supply power or fuel to the mobile device based on a position of the mobile device relative to the supply device including,
a driving unit configured to move the mobile device,
a position measuring unit configured to measure the position of the mobile device,
a route generating unit configured to generate a route from the position of the mobile device to the position of the supply device,
a controller configured to control the driving unit based on the route generated by the route generating unit,
a communicating unit configured to communicate with the supply device; and
a mobile device rechargeable power source configured to supply power to the mobile device,
the supply device configured to supply power or fuel to the mobile device, the supply device including,
a recognizing unit configured to recognize an object located within a range around the supply device,
a communicating unit configured to transmit a recognition result of the recognizing unit to the mobile device,
a charging unit configured to supply power to the mobile device battery; and
a calculator disposed in the supply device and configured to calculate a position of the mobile device relative to the supply device based on the recognition result of the recognizing unit.

7. The system according to claim 6, wherein the recognizing unit comprises an image pickup unit configured to receive images of the range around the supply device, and the calculator is configured to calculate the position of the mobile device relative to the supply device and a direction movement of the mobile device based on the images received by the image pickup unit.

8. The system according to claim 6, wherein the calculator is configured to calculate a position of the mobile device relative to the supply device and a direction of movement of the mobile device based on a difference in plural images received by the recognizing unit.

9. The system according to claim 6, wherein the recognizing unit comprises plural ranging units configured to detect a distance between the supply device and another object, and the calculator is configured to calculate a position of the mobile device relative to the supply device and a direction movement of the mobile device based on a variation of distance measured by each of the ranging units.

10. The system according to claim 6, wherein the position measuring unit is configured to set the position of the supply device as a reference position or initial position in relation to position measurement of the mobile device.

11. A mobile device system, comprising:
an image pickup unit; and
an autonomously-movable mobile device including,
a driving unit configured to move the mobile device;
a position measuring unit configured to measure a position of the mobile device,
a route generating unit configured to generate a route from the position of the mobile device to a supply device configured to supply power or fuel,
a controller configured to control the driving unit based on the route generated by the route generating unit,
a calculator configured to calculate a position of the mobile device relative to the supply device and a direction of movement of the mobile device based on images of the mobile device or images of the supply device; and
a mobile device rechargeable power source disposed in the mobile device and configured to supply power to the mobile device.

12. The mobile device according to claim 11, wherein the image pickup unit is disposed in the supply device.

13. The mobile device according to claim 11, wherein the image pickup unit is disposed in the mobile device.

14. The mobile device according to claim 11, wherein the position measuring unit is configured to set a position of the supply device as a reference position or initial position in relation to position measurement of the mobile device.

15. An autonomously-movable mobile device, comprising:
a driving unit configured to move a mobile device;
a position measuring unit configured to measure a position of the mobile device;
a route generating unit configured to generate a route between the mobile device and a supply device;
a controller configured to control the driving unit based on the route generated by the route generating unit;
a communicating unit configured to communicate with the supply device; and
a mobile device rechargeable power source disposed in the mobile device configured to supply power to the mobile device, wherein the mobile device is configured to move to a position at which the supply device can supply power to the battery based on a position of the mobile device relative to the supply device calculated by the supply device.

16. The mobile device according to claim 15, wherein a recognizing unit comprises an image pickup unit configured to receive images of an area surrounding the supply device, and a calculator is configured to calculate a position of the mobile device relative to the supply device and a direction of movement of the mobile device based on the images received by the recognizing unit.

17. The mobile device according to claim 15, wherein a calculator is configured to calculate a position of the mobile device relative to the supply device and a direction of movement of the mobile device based on a difference between images received by the recognizing unit.

18. The mobile device according to claim 15, wherein a recognizing unit comprises plural ranging units configured to detect a distance between the supply device and another object, and a calculator is configured to calculate a position of the mobile device relative to the supply device and a direction movement of the mobile device based on variation of the distance measured by each of the ranging units.

19. The mobile device system according to claim 15, wherein the position measuring unit is configured to set a position of the supply device as a reference position or initial position related to position measurement of the mobile device.

20. A method of guiding a mobile device to a supply device to recharge the mobile device, comprising:
collecting first information regarding a location of the mobile device via measurement equipment disposed in the mobile device;
storing the location of a supply device in memory;
generating a first route from the mobile device to the supply device based on the first information and the location of the supply device;
moving the mobile device along the first route;
sensing second information regarding the location and direction of movement of the mobile device via at least one sensor located on the supply device;
processing the second information to determine the location and direction of movement of the mobile device;
generating a second route from the mobile device to the supply device based on the second information;
moving the mobile device along the second route;
joining the mobile device with the supply device; and
supplying power to the mobile device from the supply device.

21. The method according to claim 20, wherein the processing of the second information is performed in the mobile device.

22. The method according to claim 20, wherein the processing of the second information is performed in the supply device.

23. A computer program product which stores computer program instructions which, when executed by a computer system programmed with the computer program instructions, results in performing the steps comprising:
receiving first information regarding a location of a mobile device;
storing second information regarding the location of a supply device;
calculating a first route between the mobile device and the supply device based on the received first information and the stored second information;
generating drive signals to a drive unit of the mobile device to move the mobile device along the calculated first route;
receiving third information from at least one sensor located on the supply device;
processing the third information to determine the location and direction of movement of the mobile device;
calculating a second route from the mobile device to the supply device; and
generating drive signals to a drive unit of the mobile device to move the mobile device along the calculated second route.

24. A system having an autonomously-movable mobile device and a supply device configured to supply power or fuel to the mobile device, comprising:
a mobile device configured to move to a position at which a supply device can supply power or fuel to the mobile device including,
a driving unit configured to move the mobile device,
a mobile device power source disposed in the mobile device and configured to supply power to the mobile device; and
means for guiding the mobile device into an area where a supply device can sense the mobile device; and
the supply device configured to supply power or fuel to the mobile device, the supply device including,
a supply device battery or supply unit configured to supply power to the mobile device power source,
a charger configured to charge the supply device battery or supply unit; and
means for guiding the mobile device into a position where the supply device can supply power to the mobile device.
